(19) United States
(12) Patent Application Publication
(10) Pub. No.: US 2017/0367513 A1
(43) Pub. Date: Dec. 28, 2017

(54) FLOOR MAT

(71) Applicant: Arrowhead Healthcare Supply, LLC, Duluth, MN (US)

(72) Inventor: David Loegering, Belle Plaine, MN (US)

(21) Appl. No.: 15/631,536

(22) Filed: Jun. 23, 2017

Related U.S. Application Data
(60) Provisional application No. 62/354,261, filed on Jun. 24, 2016.

(51) Int. Cl. A47G 27/04; E04F 15/02

(52) U.S. Cl. CPC A47G 27/0412; E04F 15/02161; B32B 2471/04

(57) ABSTRACT

A floor mat includes a body portion, a plurality of channels positioned on a top of the body portion, a plurality of supports extending away from a bottom of the body portion, and a first plurality of ribs extending between the plurality of supports on the bottom of the body portion.

### CROSS-REFERENCE TO RELATED APPLICATION(S)

This application claims priority to U.S. Provisional Application No. 62/354,261, filed on Jun. 24, 2016, and entitled “Non-Slip Wet Area Floor Mat with Impact Force Reduction,” the disclosure of which is incorporated by reference in its entirety.

### BACKGROUND

The present disclosure relates to a floor mat, and in particular to a non-slip wet area floor mat with impact force reduction.

Wet areas, such as shower, bath, and toilet areas, often become slipping hazards that can result in severe injury in the event of a fall. Traditional bath mats can provide some slip reduction by creating a non-slip surface to walk upon, but they do little to prevent severe injury should a fall still occur. Further, traditional bath mats also tend to trap and/or entrain water or other fluids, creating a breeding ground for dangerous bacteria and fungi. Traditional bath mats fail to provide structural support for impact force reduction in the event of a fall and they fail to provide for water or other fluids drainage and air circular underneath and around the mat to prevent dangerous bacteria and fungi from growing.

### SUMMARY

A floor mat includes a body portion, a plurality of channels positioned on a top of the body portion, a plurality of supports extending away from a bottom of the body portion, and a first plurality of ribs extending between the plurality of supports on the bottom of the body portion.

A floor mat includes a body portion, and a plurality of supports extending away from a bottom of the body portion. The floor mat further includes a first plurality of arched ribs extending between the plurality of supports on the bottom of the body portion, and a second plurality of arched ribs extending along a first side of each of the plurality of channels. The floor mat is made out of a flexible material.

A method of draining a fluid through a floor mat includes running a fluid across a top of a body portion of the floor mat and across a plurality of channels on the top of the body portion. The fluid is flowed through a plurality of openings extending through the body portion. The openings are positioned between the plurality of channels. The fluid is run underneath a bottom of the body portion of the floor mat around a plurality of supports and through a first plurality of arched ribs and a second plurality of arched ribs.

### BRIEF DESCRIPTION OF THE DRAWINGS

FIG. 1A is a perspective view of a floor mat.

FIG. 1B is a top plan view of the floor mat.

FIG. 2A is a bottom plan view of the floor mat.

FIG. 2B is an enlarged bottom view of a portion of the floor mat.

FIG. 2C is a partial cross-sectional view of the floor mat taken along line 2-2 of FIG. 1B.

FIG. 3A is a cross-sectional view of the floor mat taken along line 3-3 of FIG. 1B.

FIG. 3B is a cross-sectional view of the floor mat taken along line 3-3 of FIG. 1B when a force is being applied to a top of the floor mat.

FIG. 4 is a perspective view of a bottom of the floor mat.

### DETAILED DESCRIPTION

As described herein, a floor mat implementing the structures and techniques of this disclosure can reduce impact forces and the likelihood of serious injury as a result of accidental falls in wet areas, including, but not limited to, shower, bath, and toilet areas. Additionally, a floor mat implementing the structures and techniques of this disclosure provides for increased air and fluid flow around it, preventing the growth of dangerous bacteria and fungi that can occur where traditional bath mats prohibit airflow and/or tend to trap water or other fluids.

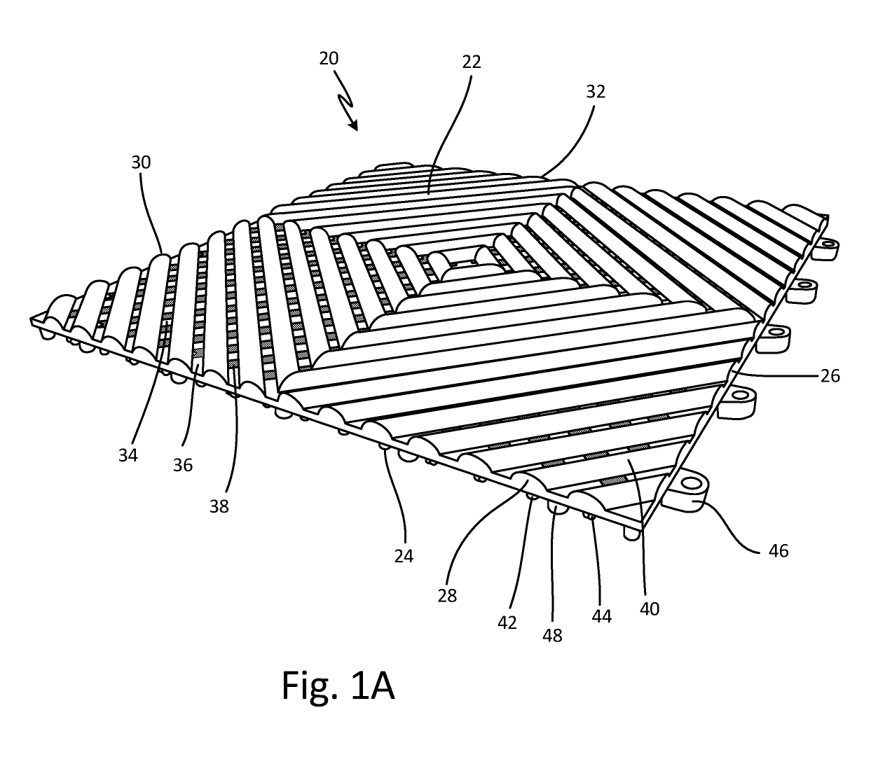

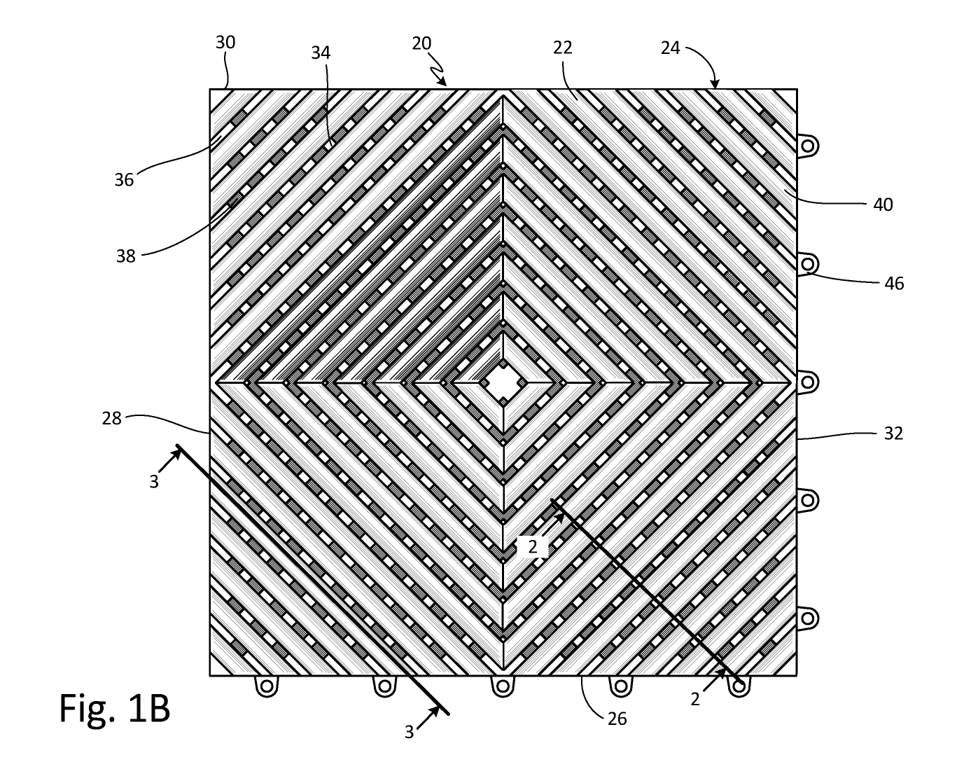

FIG. 1A is a perspective view of floor mat 20. FIG. 1B is a top plan view of floor mat 20. Floor mat 20 includes top 22, bottom 24, first side 26, second side 28, third side 30, fourth side 32, body portion 34, frame 36, openings 38, channels 40, supports 42 (shown in FIG. 1A), ribs 44 (shown in FIG. 1A), female connectors 46, and male connectors 48 (shown in FIG. 1A).

Floor mat 20 includes top 22 and bottom 24 opposite of top 22. When floor mat 20 is positioned on the floor, top 22 will face upwards away from the floor and bottom 24 will face and be positioned on the floor. Floor mat 20 further includes first side 26, second side 28, third side 30, and fourth side 32. First side 26 is positioned between second side 28 and fourth side 32, second side 28 is positioned between third side 30 and first side 26, third side 30 is positioned between fourth side 32 and second side 28, and fourth side 32 is positioned between first side 26 and third side 30.

Floor mat 20 includes body portion 34 that forms a base for floor mat 20. Body portion 34 is a square in the embodiment shown in FIG. 1. Body portion 34 can be other shapes in alternate embodiments. Frame 36 forms a perimeter of body portion 34. Frame 36 provides structural support for floor mat 20. Openings 38 are formed in body portion 34 of floor mat 20. Openings 38 are shaded for clarity in FIGS. 1A-1B. Openings 38 extend through body portion 34 from top 22 to bottom 24 of floor mat 20. Openings 38 are positioned within frame 36 in body portion 34. Openings 38 are positioned in floor mat 20 to allow water or other fluids to flow from top 22 to bottom 24 of floor mat 20.

Channels 40 are positioned on top 22 of floor mat 20 and are integrally formed with body portion 34. Channels 40 form a repeating diamond pattern on top 22 of floor mat 20. Channels 40 provide a non-slip surface on top 22 of floor mat 20 and can flex when pressure is applied to channels 40. Supports 42 and ribs 44 are positioned on bottom 24 of floor mat 20 and are connected to body portion 34. Supports 42 are cylindrical shaped posts that extend downwards from body portion 34. Supports 42 are positioned on the floor to provide structural support for floor mat 20 while allowing water or other fluids to flow around supports 42 under floor mat 20. Ribs 44 extend between supports 42 and along channels 40. Ribs 44 provide structural support for floor mat 20 and are arched to allow water or other fluids to flow beneath ribs 44 under floor mat 20.

Floor mat 20 also includes female connectors 46 and male connectors 48. Female connectors 46 are positioned on first side 26 and fourth side 32 of floor mat 20. Male connectors 48 are positioned on second side 28 and third side 30 of floor mat 20. A first floor mat 20 can be attached to a second floor mat 20 by positioning male connectors 48 of the first floor mat 20 in female connectors 46 of the second floor mat 20.

Floor mat 20 is made out of a flexible material. The flexible material that floor mat 20 is made out of can have a durometer range of about Shore A 55 to Shore A 85. Specifically, the flexible material that floor mat 20 is made out of can have a durometer of about Shore A 70. For example, floor mat 20 can be made out of plastics (e.g., polyvinyl chloride (PVC)) and rubbers. Floor mat 20 can be made using a two stage molding process or a single stage molding process. Floor mat 20 confers the advantage of reducing impact forces and the likelihood of serious injury as a result of accidental falls in wet areas. Additionally, floor mat 20 provides increased air and water or other fluids flow around it, preventing the growth of dangerous bacteria and fungi that can occur where traditional bath mats prohibit airflow and/or tend to trap water or other fluids.

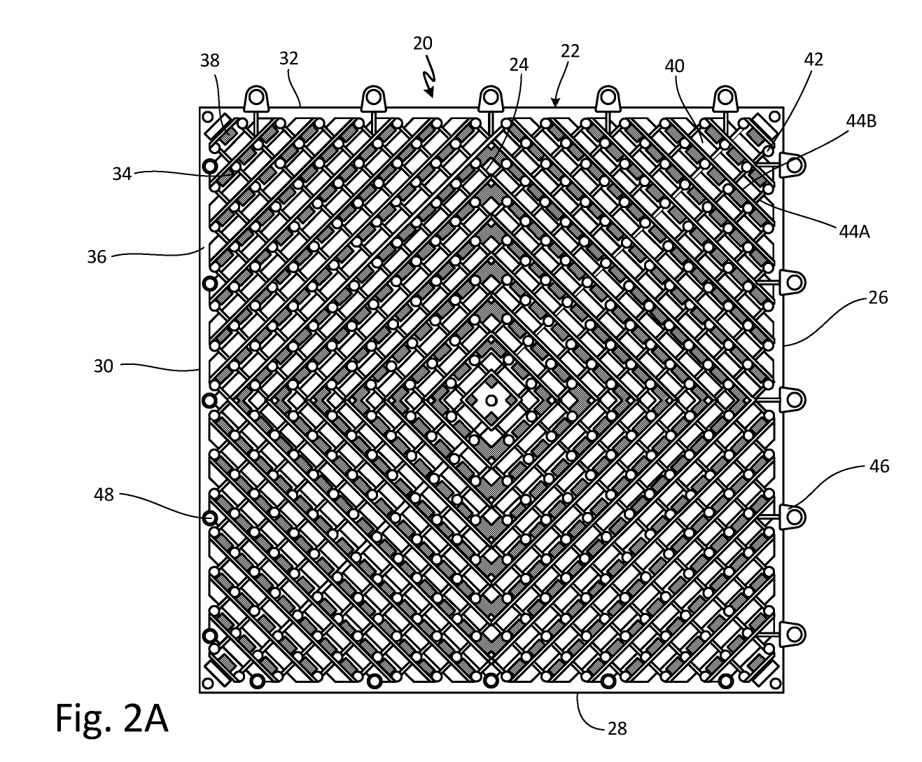

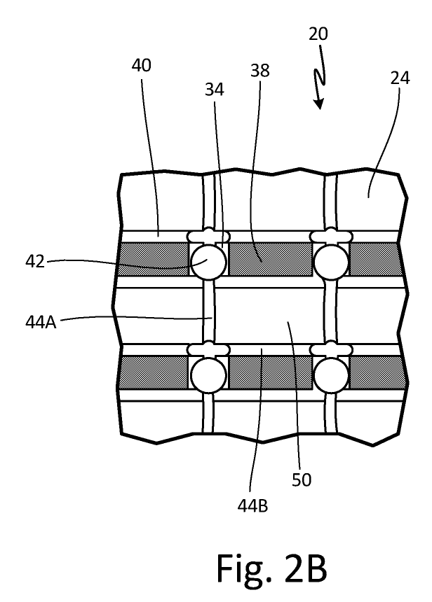

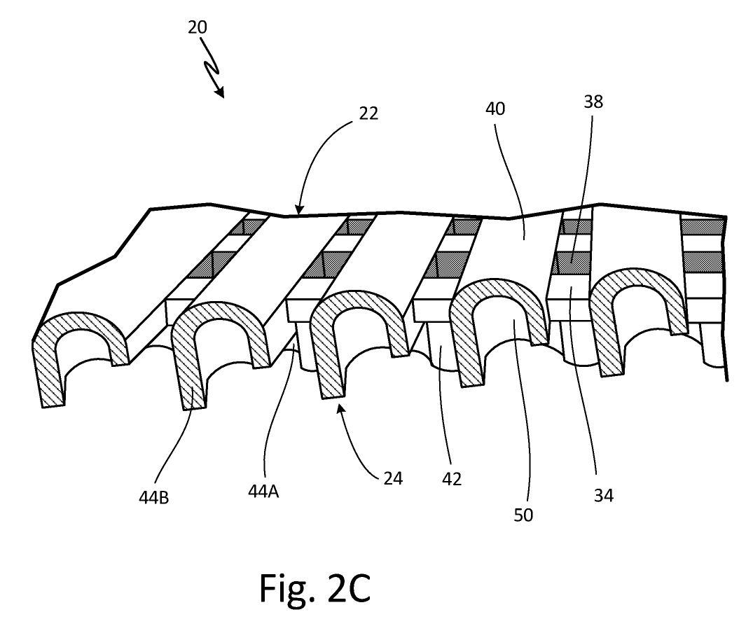

FIG. 2A is a bottom plan view of floor mat 20. FIG. 2B is an enlarged bottom view of a portion of floor mat 20. FIG. 2C is a partial cross-sectional view of floor mat 20 taken along line 2-2 of FIG. 1B. Floor mat 20 includes top 22 (shown in FIGS. 2A and 2C), bottom 24, first side 26 (shown in FIG. 2A), second side 28 (shown in FIG. 2A), third side 30 (shown in FIG. 2A), fourth side 32 (shown in FIG. 2A), body portion 34, frame 36 (shown in FIG. 2A), openings 38, channels 40, supports 42, ribs 44A and 44B, female connectors 46 (shown in FIG. 2A), male connectors 48 (shown in FIG. 2A), and cavities 50.

Floor mat 20 includes top 22 and bottom 24. Floor mat 20 further includes first side 26, second side 28, third side 30, and fourth side 32. Body portion 34 forms a base for floor mat 20. Frame 36 extends around a perimeter of body portion 34. Openings 38 are formed in body portion 34. Openings 38 are shaded for clarity in FIGS. 2A-2C. Channels 40 are positioned on top 22 of floor mat 20 and supports 42 and ribs 44 are positioned on bottom 24 of floor mat 20. Female connectors 46 are positioned on first side 26 and fourth side 32 of floor mat 20. Male connectors 48 are positioned on second side 28 and third side 30 of floor mat 20.

Channels 40 extend along top 22 of floor mat 20 in a repeating diamond pattern. Channels 40 are positioned to run between supports 42. Channels 40 have a cross-section that is shaped as a semi-circle in the embodiment shown in FIGS. 2A-2C. In alternate embodiments, channels 40 can have a cross-section that is square shaped. Channels 40 include cavities 50 that are formed on a bottom surface of channels 40. Cavities 50 are includes on the bottom surface of channels 40 to allow the channels additional flexibility when downward pressure is applied to the top surface of channels 40. Channels 40 will flex when pressure is applied to channels 40.

Supports 42 extend downwards from and are integrally formed with body portion 34 of floor mat 20. Supports 42 are cylindrical shaped posts in the embodiment shown in FIGS. 2A-2C, but can be any suitable shape in alternate embodiments. Further, in the embodiment shown in FIGS. 2A-2C, supports 42 are all the same height and will all contact the floor when floor mat 20 is positioned on the floor. In alternate embodiments, supports 42 can have varying heights and some supports 42 may not contact the floor when floor mat 20 is positioned on the floor. In this embodiment, supports 42 that do not contact the floor when floor mat 20 is positioned on the floor may come into contact with the floor when pressure is applied to top 20 of floor mat 20. Supports 42 are positioned on bottom 24 of floor mat 20 to provide structural support for floor mat 20 when floor mat 20 is positioned on the floor, while allowing water or other fluids to flow around supports 42 under floor mat 20 when floor mat 20 is positioned on the floor.

Ribs 44 include first ribs 44A and second ribs 44B. First ribs 44A extend between supports 42. First ribs 44A extend across channels 40, bounding opposite ends of cavities 50 on the bottom surface of channels 40. Second ribs 44B extend along a first side of channels 40. Second ribs 44B abut supports 42 on a first side of supports 42. First ribs 44A are perpendicular to second ribs 44B. First ribs 44A and second ribs 44B are arched so that water or other fluids can flow beneath first ribs 44A and second ribs 44B under floor mat 20. First ribs 44A and second ribs 44B do not contact the floor when floor mat 20 is positioned on the floor but can contact the floor when pressure is applied to top 22 of floor mat 20.

Openings 38 extend through body portion 34. Openings 38 are positioned between channels 40 and supports 42. Ribs 44B extend along a first side of openings 38 along the first side of channels 40. Openings 38 allow water or other fluids to flow from top 22 to bottom 24 of floor mat 20 through body portion 34. Openings 38 allow floor mat 20 to be positioned in a wet area, as water or other fluids on top 22 of floor mat 20 will drain through openings 38.

Floor mat 20 absorbs impact forces and allows both air and water or other fluids to flow about it. Channels 40 flex when a force is applied to floor mat 20 in order to absorb the force of an impact and reduce the severity of injury as the result of a fall. Supports 42 and ribs 44A and 44B are positioned on bottom 24 of floor mat 20 and provide additional structural support and impact reduction for floor mat 20. Supports 42 further provide separation of bottom 24 of floor mat 20 from the floor underneath floor mat 20. As such, water or other fluids and air can flow around supports 42 and ribs 44A and 44B to prevent water or other fluids from being trapped underneath floor mat 20, to facilitate drying underneath floor mat 20, and to prevent the growth of dangerous bacteria and fungi underneath and around floor mat 20. Openings 38 are provided in floor mat 20 to allow water or other fluids and air to flow through body portion 34 of floor mat 20 to drain water or other fluids on top 22 of floor mat 20 through floor mat 20 to a drain in the floor. Further, openings 38 allow air to flow through floor mat 20 to dry the area underneath floor mat 20.

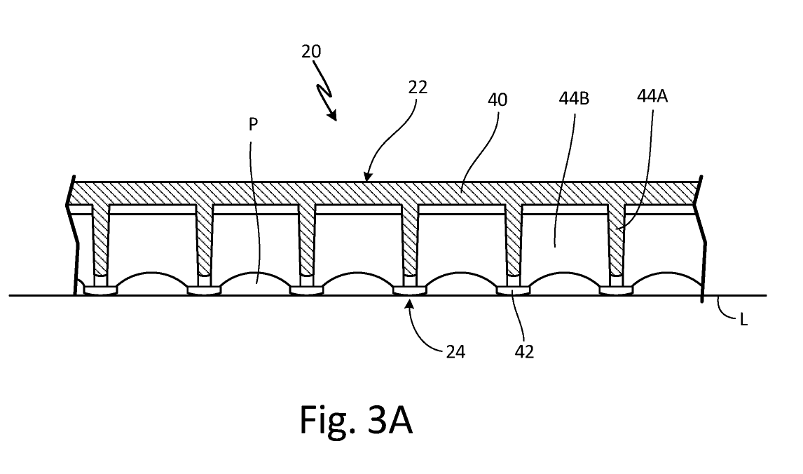

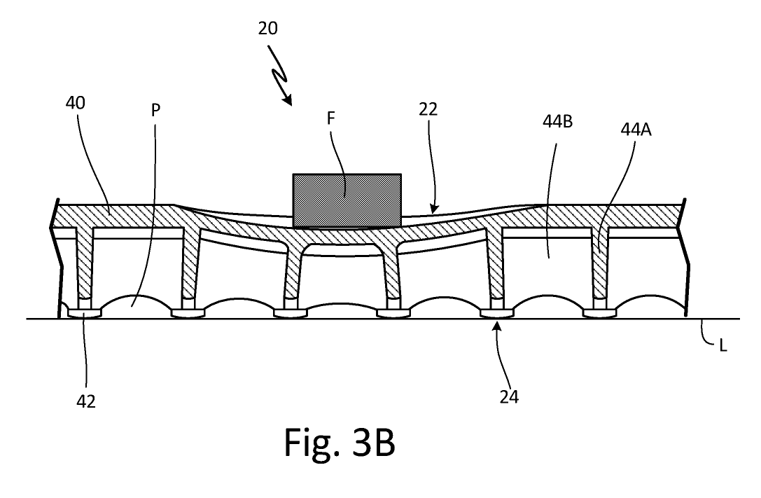

FIG. 3A is a cross-sectional view of floor mat 20 taken along line 3-3 of FIG. 1B. FIG. 3B is a cross-sectional view of floor mat 20 taken along line 3-3 of FIG. 1B when force F is being applied to top 22 of floor mat 20. Floor mat 20 includes top 22, bottom 24, channels 40, supports 42, and ribs 44A and 44B. Also shown in FIGS. 3A-3B is floor L and openings P. Also shown in FIG. 3B is force F.

Floor mat 20 includes top 22 and bottom 24. Channels 40 are positioned on top 22 of floor mat 20 and supports 42 and ribs 44A and 44B are positioned on bottom 24 of floor mat 20. Ribs 44A extend between supports 42 and ribs 44B extend along a first side of channels 40. As shown in FIGS. 3A-3B, supports 42 contact floor L and support floor mat 20 on floor L. Ribs 44A and 44B are positioned on bottom 24 of floor mat 20 but do not contact floor L when floor mat 20 is positioned on floor 20. Ribs 44A and 44B are arched to create openings P between floor L and ribs 44A and 44B. When floor mat 20 is positioned on floor L, water or other fluids and air can flow through openings P.

As seen in FIG. 3B, when force F is applied to top 22 of floor mat 20, ribs 44A and 44B will deflect and can come into contact with floor L. The deflection of ribs 44A and 44B help to absorb impact in floor mat 20. Ribs 44A and 44B provide structural support for floor mat 20.

As shown in FIG. 3A, when floor mat 20 is positioned on floor L, water or other fluids and air can flow around supports 42 and underneath ribs 44A and 44B to drain water or other fluids and dry an area under floor mat 20 to prevent the growth of dangerous bacteria and fungi under and around floor mat 20. Supports 42 and ribs 44A and 44B also provide structural support and impact force reduction for floor mat 20. If a fall were to occur on floor mat 20, ribs 44A and 44B can flex to absorb the impact of the fall, thus helping to prevent serious injury from occurring.

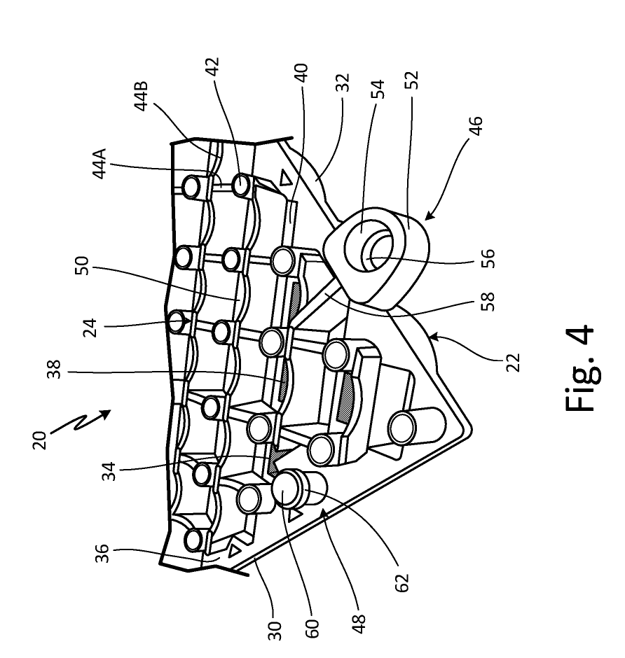

FIG. 4 is a perspective view of bottom 24 of floor mat 20. Floor mat 20 includes top 22, bottom 24, third side 30, fourth side 32, body portion 34, frame 36, openings 38, channels 40, supports 42, ribs 44, female connectors 46, male connectors 48, cavities 50, body portion 52, aperture 54, rim 56, support rib 58, post 60, and ridge 62.

Floor mat 20 includes top 22 and bottom 24. Floor mat 20 further includes third side 30, and fourth side 32. Body portion 34 forms a base for floor mat 20. Frame 36 extends around a perimeter of body portion 34. Openings 38 are formed in body portion 34. Openings 38 are shaded for clarity in FIG. 4. Channels 40 are positioned on top 22 of floor mat 20 and supports 42 and ribs 44 are positioned on bottom 24 of floor mat 20. Female connectors 46 are positioned on fourth side 32 of floor mat 20. Male connectors 48 are positioned on third side 30 of floor mat 20. Cavities 50 are formed in a bottom surface of channels 40.

A single female connector 46 is shown in FIG. 4, however there are a number of female connectors 46 positioned along fourth side 32 of floor mat 20. Female connector 46 include body portion 52. Aperture 54 is extends through body portion 52 of female connector 46. Rim 56 is positioned in aperture 54 on a top of body portion 52. Support rib 58 extends from one rib 44B to body portion 52 to provide structural support for body portion 52.

A single male connector 48 is shown in FIG. 4, however there are a number of male connectors 48 positioned along third side 30 of floor mat 20. Male connector 38 includes post 60. Post 60 is a cylindrical post that extends from frame 36 of body portion 34 of floor mat 20. Ridge 62 is positioned on post 60 between a first end and a second end of post 60.

Floor mat 20 is a modular floor mat. Any number of floor mats 20 can be connected together using female connectors 46 and male connectors 48 to form a floor mat of a desirable shape and size. To connect female connectors 46 with male connectors 48, posts 60 of male connectors 48 are positioned in apertures 54 in body portions 52 of female connectors 46. Ridges 62 on posts 60 can be pressed into apertures 54 of female connectors 46 past rims 56 of female connectors 46. Ridges 62 of male connectors 48 help to hold posts 60 of male connectors 48 in place in apertures 54 of female connectors 46, as some force is required to pull ridges 62 past rims 56 of female connectors 46 to remove posts 60 of male connectors 48 from apertures 54 of female connectors 46.

Floor mat 20 is made out of a flexible material to allow it to flex and absorb impact forces. Floor mat 20 is designed to structurally support weight that is placed on it and to absorb impact forces if a fall were to happen on floor mat 20. Floor mat 20 also allows water or other fluids to drain through floor mat 20 and run freely underneath floor mat 20. Floor mat 20 is designed to allow air to circulate under and around floor mat 20 to facilitate drying of the area under and around floor mat 20 to prevent dangerous bacteria and fungi from growing.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A floor mat comprising:
a body portion;
a plurality of channels positioned on a top of the body portion;
a plurality of supports extending away from a bottom of the body portion; and
a first plurality of ribs extending between the plurality of supports on the bottom of the body portion.

2. The floor mat of claim 1, wherein the floor mat is made out of a flexible material with a durometer of about Shore A 55 to Shore A 85.

3. The floor mat of claim 1, wherein the plurality of supports are longer than the first plurality of ribs.

4. The floor mat of claim 1, wherein the first plurality of ribs are arched.

5. The floor mat of claim 1, wherein there is a cavity formed on a bottom of each channel.

6. The floor mat of claim 1, and further comprising:
a plurality of openings extending through the body portion and positioned between the plurality of channels and the plurality of supports.

7. The floor mat of claim 1, and further comprising:
a second plurality of ribs extending along a first side of each of the plurality of channels.

8. The floor mat of claim 7, wherein the plurality of supports are longer than the second plurality of ribs.

9. The floor mat of claim 7, wherein the second plurality of ribs are arched.

10. The floor mat of claim 7, and further comprising:
a plurality of female connectors connected to a first side of the floor mat; and
a plurality of male connectors connected to a second side of the floor mat.

11. The floor mat of claim 10, and further comprising:
a plurality of structural ribs, wherein each of the plurality of structural ribs extends from one of the second plurality of ribs to one of the plurality of female connectors.

12. A floor mat comprising:
a body portion;
a plurality of supports extending away from a bottom of the body portion;
a first plurality of arched ribs extending between the plurality of supports on the bottom of the body portion; and
a second plurality of arched ribs extending along a first side of each of the plurality of channels;
wherein the floor mat is made out of a flexible material.

13. The floor mat of claim 12, wherein the plurality of supports are longer than the first plurality of arched ribs and the second plurality of arched ribs.

14. The floor mat of claim 12, wherein the first plurality of arched ribs are perpendicular to the second plurality of arched ribs.

15. The floor mat of claim 12, and further comprising:
a plurality of channels positioned on a top of the body portion, wherein there is a cavity formed on a bottom of each channel.

16. The floor mat of claim 12, and further comprising:
a plurality of openings extending through the body portion and positioned between the plurality of channels and the plurality of supports.

17. The floor mat of claim 12, and further comprising:
a plurality of female connectors connected to a first side of the floor mat;
a plurality of male connectors connected to a second side of the floor mat; and
a plurality of structural ribs, wherein each of the plurality of structural ribs extends from one of the second plurality of arched ribs to one of the plurality of female connectors.

18. A method of draining a fluid through a floor mat comprising:
running a fluid across a top of a body portion of the floor mat and across a plurality of channels on the top of the body portion;
flowing the fluid through a plurality of openings extending through the body portion, wherein the openings are positioned between the plurality of channels; and
running the fluid underneath a bottom of the body portion of the floor mat around a plurality of supports and through a first plurality of arched ribs and a second plurality of arched ribs.

19. The method of claim 18, wherein the floor mat is made out of a flexible material with a durometer of about Shore A 55 to Shore A 85.

20. The method of claim 18, wherein the first plurality of arched ribs are perpendicular to the second plurality of arched ribs.
